(19) United States
(12) Patent Application Publication
(10) Pub. No.: US 2016/0298367 A1
(43) Pub. Date: Oct. 13, 2016

(54) FLUSH BOLT AND DOOR-SEALING SYSTEM

(71) Applicant: PLANET GDZ AG, Tagelswangen (CH)

(72) Inventor: Andreas DINTHEER, Illnau (CH)

(21) Appl. No.: 15/038,659

(22) PCT Filed: Nov. 10, 2014
(86) PCT No.: PCT/EP2014/074132

§ 371 Date: May 23, 2016

(30) Foreign Application Priority Data
Nov. 21, 2013 (EP) 13193772.4

(51) Int. Cl. E05C 19/02; E06B 7/18; E05C 19/06; E05C 1/00; E05C 1/08

(52) U.S. Cl. CPC E05C 19/028; E05C 1/002; E05C 1/085; E05C 19/063; E06B 7/18

(57) ABSTRACT

An automatically actuable flush-bolt mechanism has a triggering element (50) which automatically displaces a locking bolt (6) from a starting position into a locking position. A restoring spring (55) restores the locking bolt (6) into the starting position. In the event of misalignment, an automatic override function overrides the actuating mechanism in order to prevent the locking bolt (6) from being lowered all the way into the locking position. The actuating mechanism has a displacement element (52), on which the locking bolt (6) rests by way of a driver (8) and with which the locking bolt (6) can be brought into the locking position. The displacement element (52) can be displaced in the direction of the longitudinal center axis (a) relative to the locking bolt (6) and driver (8), wherein overriding takes place by virtue of this displacement capability.

### TECHNICAL FIELD

The present invention relates to an automatically actuable flush-bolt mechanism and to a door-sealing system having such a flush-bolt mechanism.

### PRIOR ART

EP 1 308 590 discloses a combination of a flush-bolt mechanism with an automatically lowerable door seal. The door seal, for this purpose, has a through-opening, which has a locking bolt of the flush-bolt mechanism passing through it. The door seal is actuated via a triggering button, which projects laterally in front of the door leaf, for closing and opening the door leaf. The flush-bolt mechanism is lowered and raised independent thereof by means of a manually actuable lever.

The prior art also discloses automatically lowerable flush-bolt mechanisms. For example, U.S. Pat. No. 4,445,717 discloses a flush-bolt mechanism having automatic triggering for closing the door. A lug is provided for this purpose, said lug projecting in front of the lateral end surface of the door leaf and being connected to the locking bolt via a toggle lever. The bolt is lowered downward counter to a spring force. For opening the door, the bolt is raised again on account of the restoring spring force. This apparatus also has a safeguard mechanism in the event of misalignment of the locking bolt. Should the bolt, during the operation of the door being closed, end up located alongside the locking hollow, then the multi-part bolt is pushed together counter to a second spring force.

U.S. Pat. No. 6,409,231 likewise has a safeguard for misalignments, wherein here, in the event of misalignment, the bolt is raised, as a result of which a compression spring arranged on the toggle lever is subjected to stressing. A similar arrangement is also disclosed in U.S. Pat. No. 4,005,886.

U.S. Pat. No. 5,004,277 discloses a slot along which a vertical connecting rod can move in order to compensate for misalignment.

### DESCRIPTION OF THE INVENTION

It is an object of the invention to provide an automatically actuable flush-bolt mechanism which has an override function for the actuating mechanism in the event of misalignment and is relatively straightforward and cost-effective to produce.

This object is achieved by the flush-bolt mechanism having the features of patent claim 1 and by a door-sealing system having the features of patent claim 13.

The automatically actuable flush-bolt mechanism according to the invention has a fastening rail for fastening the flush-bolt mechanism in or on a door leaf, and also has an actuating mechanism and a locking bolt with a longitudinal center axis. The actuating mechanism comprises a triggering element for automatically displacing the locking bolt from a starting position into a locking position, and also comprises a restoring spring for restoring the locking bolt from the locking position into the starting position. The flush-bolt mechanism also has an automatic override function which, in the event of misalignment of the locking bolt, automatically overrides the actuating mechanism in order to prevent the locking bolt from being lowered all the way into the locking position. The actuating mechanism has a displacement element, on which the locking bolt rests by way of a driver, wherein the locking bolt can be brought into the locking position by way of the displacement element being moved, and wherein the displacement element can be brought into the starting position, together with the driver resting thereon and the locking bolt, by means of the restoring spring. The locking bolt, together with the driver, can be displaced in the direction of the longitudinal center axis relative to the displacement element, wherein overriding takes place by virtue of said displacement capability.

The locking bolt is thus lowered when the displacement element is displaced downward. In the case of a counteracting force, e.g. in the event of incorrect positioning of the locking bolt, the latter remains in position even if the displacement element continues to move downward. When the displacement element is raised, it takes the locking bolt back into the starting position again, if the locking bolt is located in an intermediate position.

Incorrect positioning of the locking bolt occurs, for example, if there is no locking hollow present or if the locking hollow present is not in the proper position. Incorrect positioning also occurs, for example, when the locking hollow is too shallow in relation to the length of the bolt and the bolt thus cannot penetrate to a sufficient depth into the hollow.

The displacement element preferably forms a bearing surface, which has the locking bolt passing through it in a displaceable manner and on which the driver rests. The bearing surface preferably has a through-opening, which has the locking bolt passing through it in a displaceable manner. This arrangement is straightforward to assemble and different shapes of locking bolt can be used.

In a preferred embodiment, the restoring spring is a compression spring, wherein the displacement element presses onto said restoring spring. This minimizes the number of parts required.

In a preferred embodiment, the displacement element is of u-shaped design and has an upper and a lower limb. The lower limb butts with sliding action against a stop surface of the fastening rail, and the upper limb is designed to be longer than the lower limb and has the locking bolt passing through it in a displaceable manner. This is a straightforward way of providing, with the lowest possible outlay, for the double function of the displacement element, i.e. actuation of the locking bolt and subjecting the restoring spring to stressing.

The displacement element is preferably a pressure-exerting plate which acts on the compression spring. This arrangement allows the height of the flush-bolt mechanism to be minimized. In particular, the triggering element of the actuating mechanism may be the uppermost element of the flush-bolt mechanism, with the exception of the fastening rail. In addition, the assembly of the flush-bolt mechanism is simplified as a result of the pressure-exerting plate.

In a preferred embodiment, the actuating mechanism has a toggle lever with a first limb or arm and with a second limb or arm, which is connected in a pivotable manner to the first arm, wherein the first arm is provided with the triggering element, which projects in front of the fastening rail, and wherein the second arm is operatively connected to the displacement element. This allows optimum force transmission and minimizes the amount of space required. The second arm may be connected in a fixed or releasable manner to the displacement element. It is preferable for it to rest merely loosely thereon.

The fastening rail preferably has a front plate for bearing on an end side or a side surface of the door leaf. It may also be recessed. The locking bolt is preferably spaced apart from said front plate such that the toggle lever is located between the longitudinal center axis of the locking bolt and the front plate. The toggle lever is thus designed to be small enough for the locking bolt to be able to move upward, in the direction of its longitudinal center axis, past the toggle lever. This also minimizes the overall size of the flush-bolt mechanism.

The restoring spring is preferably spaced apart from the longitudinal center axis. The restoring spring is preferably arranged between the fastening rail and locking bolt. This arrangement allows the locking bolt to be offset in relation to the fastening rail, without the overall amount of space required for the flush-bolt mechanism being significantly increased as a result. The offsetting takes place in a direction perpendicular to the longitudinal center axis. It is beneficial, in particular in modern architecture, for the flush-bolt mechanism to be small, since the use of a small flush-bolt mechanism does not have any significant impact on the flexibility in the door design.

This arrangement of the locking bolt and of the restoring spring simplifies interaction with a door seal, in particular an automatically lowerable drop-down seal. The locking bolt can also be combined with other types of door seal, for example with manually actuable drop-down seals or with slide seals. Since the locking bolt, by virtue of its lateral offsetting, passes through the door seal at a distance from that end of the seal which is located at the end-side region of the door, it is also the case that this end-side region of the door leaf can be sufficiently sealed when the door is in the closed state. It is also possible, however, for the flush-bolt mechanism according to the invention to be used without drop-down seals.

In a preferred embodiment, the flush-bolt mechanism also has a force-transmitting spring, which acts on the locking bolt by way of a first end and acts on the displacement element by way of a second end. By means of said force-transmitting spring, the lowering force which acts on the displacement element when the triggering element is activated is transmitted, at least in part, to the locking bolt. If the locking bolt, during the lowering operation, strikes against an obstruction, then the force-transmitting spring in the first instance continues to push the bolt downward. A small obstruction, or one which can be displaced with a small amount of force, can thus be overcome by the bolt. This is advantageous, in particular, in the case of the flush-bolt mechanism being used with a seal, for the purpose of overcoming frictional forces between elements of the seal and of the locking bolt during the lowering operation. However, if increased force has to be applied in order to overcome the obstruction, then the override function takes effect and the locking bolt remains in place and is thus displaced relative to the displacement element, which continues to be lowered downward. Such relatively large obstructions are constituted, for example, by the aforementioned incorrect positioning of the bolt.

The force-transmitting spring preferably surrounds the locking bolt, wherein the force-transmitting spring butts, by way of a first end, against the displacement element, on a side of the latter which is located opposite the driver, and rests, by way of a second end, on a bearing surface, which surrounds the locking bolt and is fixed thereto. The force-transmitting spring is preferably a compression spring. This simplifies the assembly of the door-sealing system and minimizes the size of the system.

The restoring spring and the force-transmitting spring preferably each have a longitudinal axis, said longitudinal axes being spaced apart from, and parallel to, one another.

In a preferred embodiment, the fastening rail has a first guide element, and the driver has a second guide element, which is in engagement with the first guide element. The locking bolt, in the case of the actuating mechanism being overridden, can be displaced rectilinearly along its longitudinal center axis by means of said two guide elements. This guidance is advantageous in the case of all the flush-bolt-mechanism embodiments according to the invention. It is beneficial in particular in the case of use with a door seal, since it is also the case here that the flush-bolt mechanism cannot be displaced transversely to the longitudinal direction on account of having to pass parts of the seal.

The force of the restoring spring can be selected independently of the force of a force-transmitting spring. It is possible to use, in particular, relatively lightweight springs.

The door-sealing system according to the invention has a door seal and a flush-bolt mechanism, wherein the door seal has a seal housing and a sealing element, and wherein the seal housing and the sealing element each have a through-passage opening through which to guide the locking bolt. The door seal preferably has a carrier rail with a sealing element arranged thereon, wherein the carrier rail, together with the sealing element, can be lowered and raised automatically in relation to the seal housing. The operation of lowering and raising the sealing element is preferably independent of the actuation of the locking bolt.

Further embodiments are specified in the dependent claims.

### BRIEF DESCRIPTION OF THE DRAWINGS

A preferred embodiment of the invention will be described hereinbelow with reference to the drawings, which serve merely for explanatory purposes and should not be interpreted as being restrictive. In the drawings:

FIG. 1 shows a perspective illustration of a door-sealing system having a flush-bolt mechanism according to the invention in combination with a drop-down seal;

FIG. 2 shows a front view of the door-sealing system according to FIG. 1;

FIG. 3 shows a side view of the door-sealing system according to FIG. 1;

FIG. 4 shows different variants of a cross section of a locking bolt according to FIG. 1;

FIG. 5 shows a view of the door-sealing system according to FIG. 1 as seen from above;

FIG. 6 shows a first variant of the door-sealing system in the view according to FIG. 5;

FIG. 7 shows a second variant of the door-sealing system in the view according to FIG. 5;

FIG. 8 shows a second perspective view of the door-sealing system according to FIG. 1;

FIG. 9 shows a longitudinal section through the door-sealing system according to FIG. 1 in an unactuated an thus raised, starting position of the locking bolt;

FIG. 10 shows a longitudinal section through the door-sealing system according to FIG. 1 in an actuated and thus lowered, locking position of the locking bolt; and

FIG. 11 shows a longitudinal section through the door-sealing system according to FIG. 1 in the event of misalignment with the actuating mechanism overridden.

### DESCRIPTION OF PREFERRED EMBODIMENTS

The figures show a door-sealing system according to the invention having a flush-bolt mechanism according to the invention and having a door seal. Such door-sealing systems are usually used in multi-leaf doors. The flush-bolt mechanism here is preferably arranged in the inactive leaf, i.e. in that door leaf of the door comprising two or more leaves which usually remains closed or still has to be fixed separately in order for the multi-leaf door to remain closed. The flush-bolt mechanism is arranged on the lock side, that is to say facing toward the other leaf, the active leaf.

In the solution according to the invention, the flush-bolt mechanism is raised when the active leaf is opened. It is thus also possible for the inactive leaf to be moved. This door-sealing system is suitable for all types of multi-leaf doors, in particular also for fire- and smoke-protection doors.

The door seal in this example is a door seal which can be lowered automatically by mechanical means. It is fastened, for example screwed, on a lower end side, or in an end-side groove, of a door leaf. Such door seals usually serve to protect against light passing through from one room to another, to provide sound insulation and to provide protection against drafts. Such door seals are known, for example, from EP 0 338 974. If the seal is used in Minergie® buildings (low-energy-consumption buildings), it usually has an air channel in order for air to pass through from one room of the building to the adjacent room.

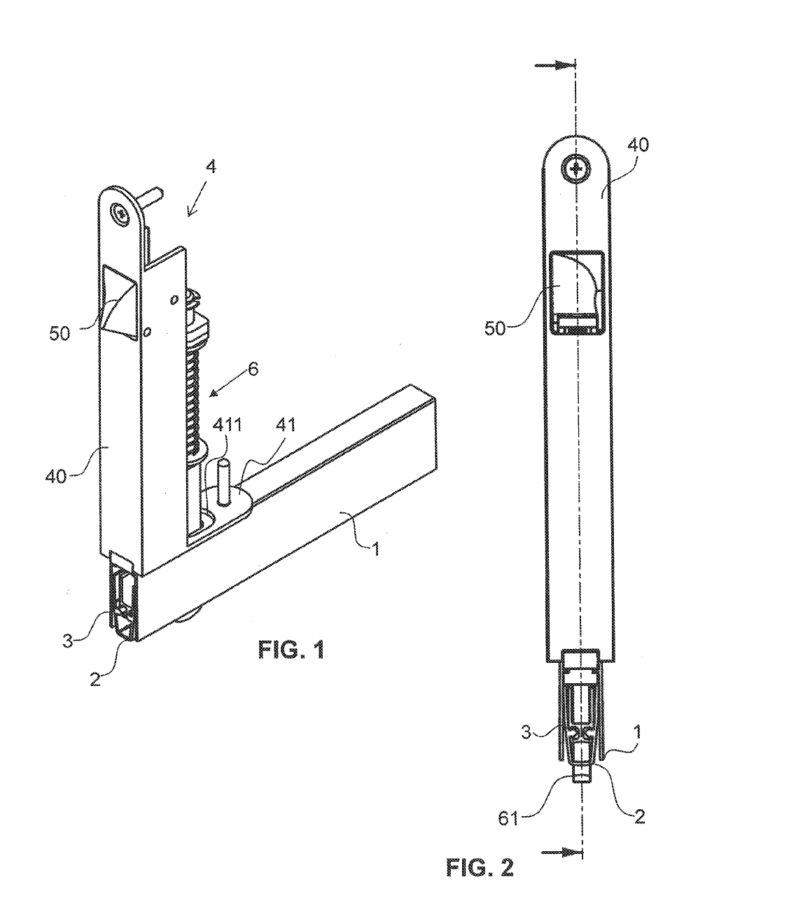

The door seal, as can be seen in FIGS. 1 and 2, has a seal housing 1 with a carrier rail 3 retained therein. The housing 1 and rail 3 are produced preferably from an aluminum profile. The two are preferably of u-shaped design, wherein the housing 1 is designed to be open in the downward direction and the carrier rail 3 is designed to be open preferably in the upward direction. The carrier rail 3 has fastened on it a sealing element 2 which is in one or more pieces and consists preferably of an elastomeric material, for example silicone.

The carrier rail 3, together with the sealing element 2, can be raised and lowered relative to the seal housing 1. A lowering mechanism (not visible) which can be activated automatically by mechanical means, and is likewise known from the prior art, is present for this purpose. Such lowering mechanisms are disclosed, for example, in EP 0 509 961, DE 19 516 530, DE 35 26 720 and DE 34 27 938. Activation takes place preferably on one side. For this purpose, a triggering element in the form of a spring-loaded actuating bar projects in front of the seal, preferably on an end side, said actuating bar, during the operation of the door leaf being closed, butting against the lateral door frame and thus being pushed in. The bar is connected to a force-transmitting rod, which runs in the upper region of the housing 1. It is also the case that one or more leaf springs are retained in the housing, said leaf springs being fastened on the force-transmitting rod by way of their first end in each case and being fastened on the housing 1 by way of their second end in each case. A central region of the leaf springs is fastened on the carrier rail 3 in each case. If the actuating bar is pushed in, the leaf springs are compressed and the carrier rail 3 is lowered. The sealing element 2 rests with sealing action on the floor and closes the gap between the underside of the door leaf and the floor. If the door is opened again, the leaf springs are relieved of loading again and the carrier rail 3, together with the sealing element 2, is raised again.

It is, of course, also possible for the flush-bolt mechanism according to the invention to be used with a door seal which has a different lowering mechanism which can be activated automatically by mechanical means. It is likewise possible for the housing 1 to have arranged in it merely a slide seal, which cannot be raised and lowered relative to the housing. Furthermore, it is possible for a magnetic seal to be arranged in the housing 1 or for the seal to be activated electrically.

The flush-bolt mechanism according to the invention has a housing, in this case referred to as fastening rail 4, for fastening on or in an end side of the door leaf (not illustrated here). It is preferably fastened on a lateral end side, in the lower or upper end region of the door leaf. The fastening rail 4 is preferably a u-shaped profile rail which is designed to be open in the direction of the door leaf. It consists preferably of steel. It may be fastened on the door leaf, for example, by means of a screw 42.

A fastening plate 41 is present at a lower end of the fastening rail 4. Said fastening plate is formed preferably in one piece with the rest of the fastening rail 4. It rests on an upper surface of the seal housing 1. The fastening plate 41 has a through-opening 411 in the form of a slot. Said opening 411, in the assembled state of the flush-bolt mechanism, is located above a through-opening 10 of the housing rail 1, and is preferably designed to be significantly larger than a lower end of a locking bolt 6. A screw 45, which projects upward into the door leaf, passes through the fastening plate 41. The seal housing 1 can be fastened on the door leaf by means of said screw 45.

A u-shaped fastening bracket 44 is present in the front, end-side region of the fastening rail 4. Said fastening bracket engages in the fastening rail 4 by way of one limb and in the housing rail 1 by way of a second limb, which runs parallel to the first limb. Said bracket 44 thus connects the rail 4 and housing 1 to one another in their front region. The slot 411 and the bracket 44 allow straightforward assembly of the flush-bolt mechanism and seal.

The flush-bolt mechanism according to the invention additionally has an actuating mechanism 5. The latter comprises a triggering element 50, which passes through a through-opening in a front plate 40 of the fastening rail 4 and projects in front of the latter.

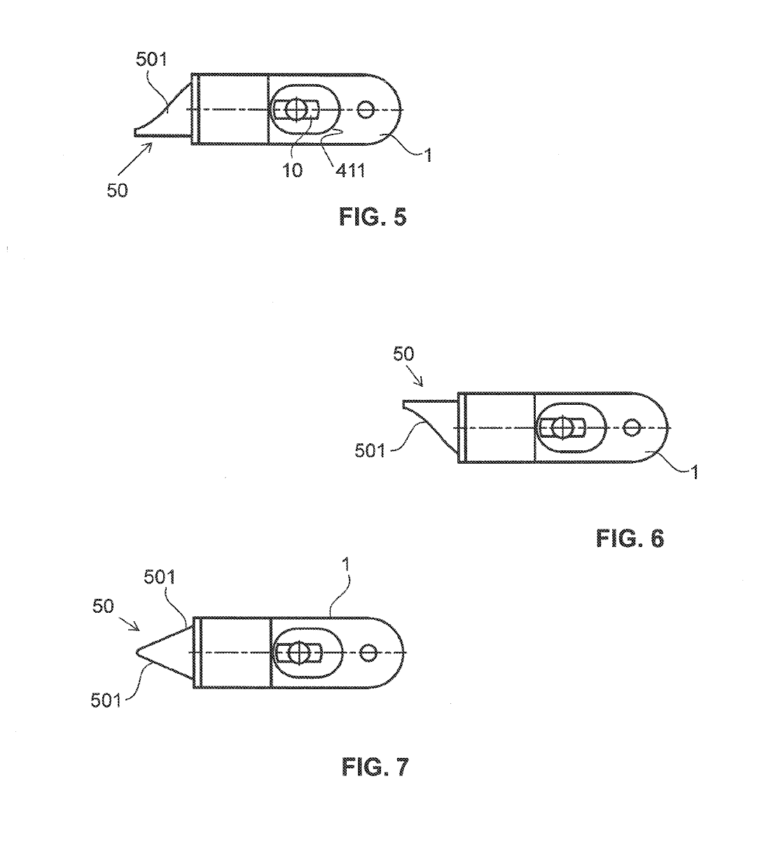

The triggering element 50 may be configured in different shapes, as the examples in FIGS. 5 to 7 show. It is thus possible, according to FIGS. 5 and 6, for it to be of asymmetrical design and to have a sloping or even curved sliding flank 501 as seen in the movement direction of the inactive leaf during the operation of closing said inactive leaf. However, it is also possible, according to FIG. 7, for it to be of symmetrical design and to have two sloping sliding flanks 501 which are located opposite one another and terminate at a common point. The flush-bolt mechanism illustrated here is activated mechanically by the triggering element 50 being pushed in during the operation of closing the inactive leaf and/or of the active leaf or as a result of some other external force being applied. If the flush-bolt mechanism is actuated electrically, e.g. by use of a motor, then the triggering element need not project. In this case, it is possible for the triggering element to be a switch which can be actuated manually and/or by means of a signal.

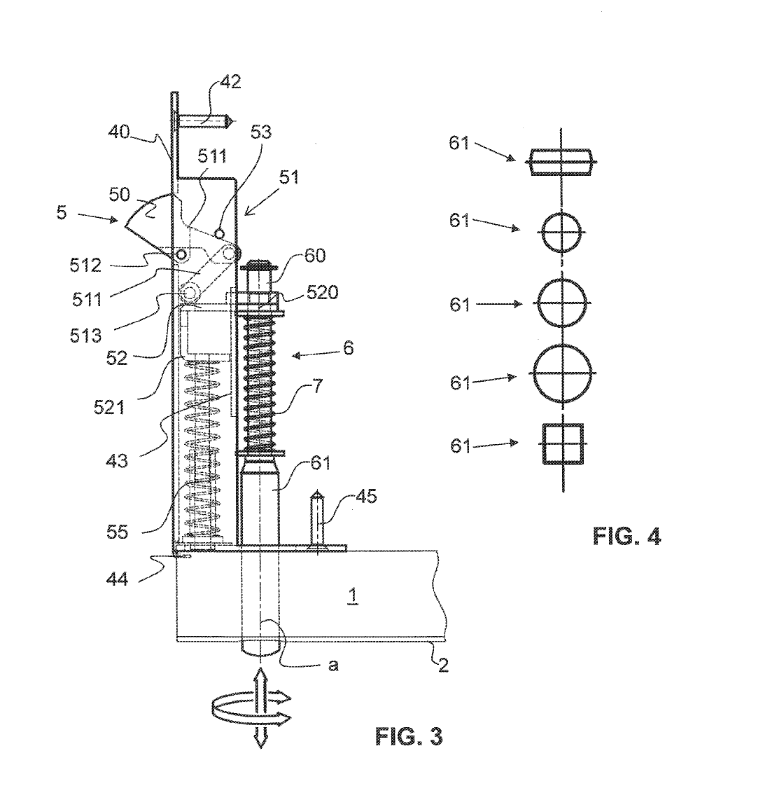

The triggering element 50, as is clearly evident in FIG. 3, is part of a toggle lever 51. The latter is arranged behind the front plate 40 and ends up located in a corresponding groove of the door leaf. The triggering element 50 forms the extension of a first limb 510 of the toggle lever 51. Said first limb 510 can be pivoted about a pivot pin 512, which is fixed to the fastening rail 4. At the free end of the first limb 510, said free end being located opposite the triggering element 50, a second limb 511 is connected in a pivotable manner to said first limb. An end of the second limb 511 which is located opposite said connection is operatively connected to a displacement element 52. The displacement element in this example is a pressure-exerting plate 52. The aforementioned end of the second limb 511 preferably rests loosely on said pressure-exerting plate 52 and can roll thereon. A corresponding rolling axis is provided with the reference sign 513. A stop pin 53 serves as an upper stop for the first limb 510, wherein the limb 510 butts against the stop pin 53 both when the triggering element 50 is projecting out of the fastening rail 4, i.e. in a starting position, and when the element 50 has been pushed all the way in, i.e. in a locking position.

The pressure-exerting plate 52 runs more or less perpendicularly to the front plate 40 and is retained within the fastening rail 4 such that it can be moved relative thereto. It is preferably of u-shaped design, wherein a first, upper limb 520 is designed to be longer than a second, lower limb 521. The lower limb 521 preferably butts with sliding action, by way of its free end, against a rear stop surface 43 of the fastening rail 4 and is thus guided in its vertical movement.

The lower limb 521 presses onto a first end of a restoring spring 55, in this case a compression spring. Said restoring spring 55 extends parallel to the front plate 40 of the fastening rail 4 and rests on the fastening plate 41 by way of its second end.

The upper limb 520 has a through-opening 522 (see FIG. 9), which has the locking bolt 6 passing through it. The locking bolt 6 has a longitudinal center axis a, which extends parallel to the longitudinal axis of the restoring spring 55.

The locking bolt 6 has an upper region—the bolt neck 60—and an adjoining, lower region—the bolt body 61. The bolt neck 60 is preferably of round cross section and is retained within the through-opening such that it can be displaced relative to the pressure-exerting plate 52. The bolt neck 60 is fixed to a driver 8, which is arranged above the upper limb 520 of the pressure-exerting plate 52 and, in a starting position, rests loosely on said upper limb. The driver 8 is designed preferably in the form of a plate. The bolt neck 61 has an external thread 63, which meshes with an internal thread of the driver 8. This means that that portion of the bolt 6 which projects downward from the pressure-exerting plate 52 can be adjusted in length. It is thus possible for the flush-bolt mechanism to be adapted correspondingly to the lowering travel of the door seal and to the distance between the floor B and underside of the door. This adjustment capability is illustrated by the circular arrow in FIG. 3.

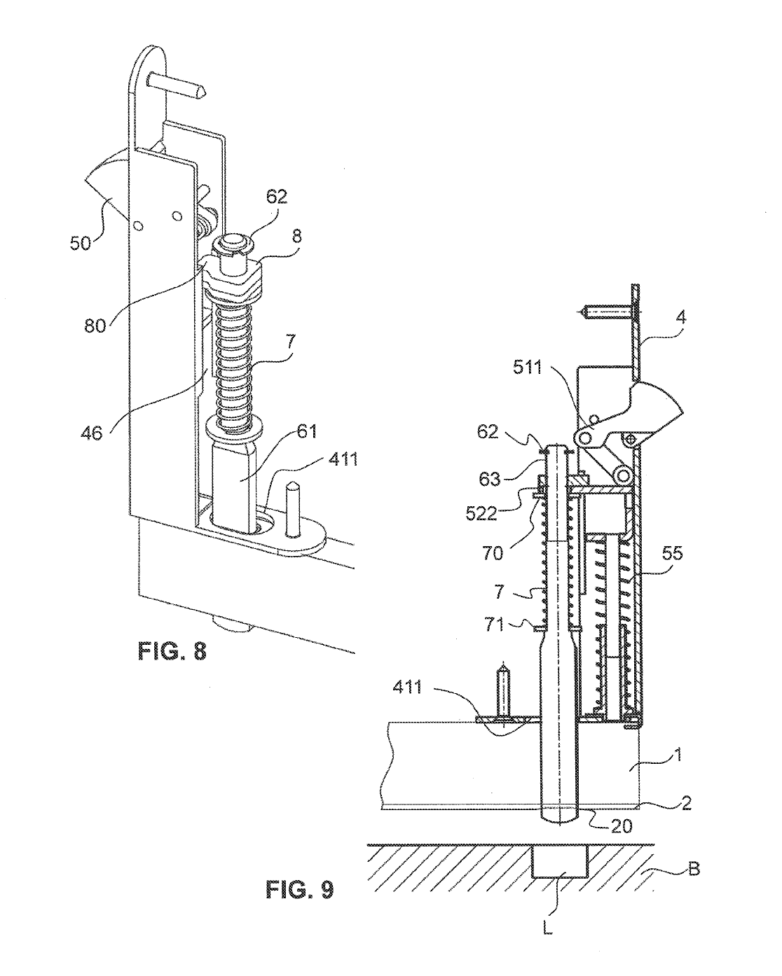

The driver 8 has a projecting lug 80, which engages in a vertically running gap 46, formed in the stop surface 43 of the fastening rail 4, and can be displaced with guidance in said gap 46. The gap 46 and lug 80 thus form a groove/sliding block connection and form a rotation-prevention means for the locking bolt 6. This can be seen in FIG. 8.

A radially outwardly projecting ring 62 is arranged at the upper free end of the bolt neck 60. It serves as an upper stop when the height of the locking bolt 6 is adjusted by means of the thread 63.

A first stop ring 70 for a force-transmitting spring 7 is present in the lower region of the bolt neck 60, i.e. beneath the pressure-exerting plate 52. It is also the case that said force-transmitting spring 7 is preferably a compression spring. It surrounds the bolt neck 60 and butts against the underside of the upper limb 520 of the pressure-exerting plate 52. For this purpose, a second stop ring 71 may be fastened on the force-transmitting spring 7. The force-transmitting spring 7 is preferably prestressed.

The cross section of the bolt body 61 may be round, rectangular, oval or square, as is illustrated in FIG. 4. It may also be of some other shape. It passes through not just the through-opening 411 in the fastening plate 41, but also through-openings in the drop-down seal. For this purpose, the seal has a through-opening 10, 20 in the housing and in the sealing element 2, and possibly in the carrier rail 3, said through-openings being in alignment with one another and with the slot 411 of the fastening plate 41. It is additionally possible for the guide element to be arranged in the drop-down seal, for the purpose of guiding the locking bolt in its movement relative to the seal. This is already known from EP 1 308 590.

In this example, the bolt body 61 projects in front of the sealing element 2 at the bottom even in the raised state, i.e. in the starting position. This need not necessarily be the case; the bolt body can also terminate within, or even above, the seal, or it may be in alignment with the lower edge of the sealing element.

FIGS. 9 to 11 will be used to describe hereinbelow the functioning of the flush-bolt mechanism according to the invention and of the door-sealing system according to the invention:

The reference sign B designates a building floor and L is a locking hollow, i.e. a depression which is located in said floor B and in which the locking bolt 6 is intended to engage during the operation of the door leaf being closed.

FIG. 9 illustrates the situation with the door open, i.e. the starting position. At least the active leaf is open. The flush-bolt mechanism illustrated and also the door seal of the inactive leaf are located in the raised state. The actuating element 50 projects in front of the front plate 40. It is also the case that the actuating rod (not illustrated) of the seal projects in front of the housing 1, as seen in the longitudinal direction of the seal. Said rod usually projects out of the other end (not illustrated) of the seal.

The toggle lever 51 in FIG. 9 is not subjected to loading and the restoring spring 55 is relieved of stressing. The pressure-exerting plate 52 is thus located in its upper position. It is also the case that the force-transmitting spring 7 is not subjected to loading and the locking bolt 7, although passing through the seal, has its lower end nevertheless spaced apart from the floor B and from the locking hollow L.

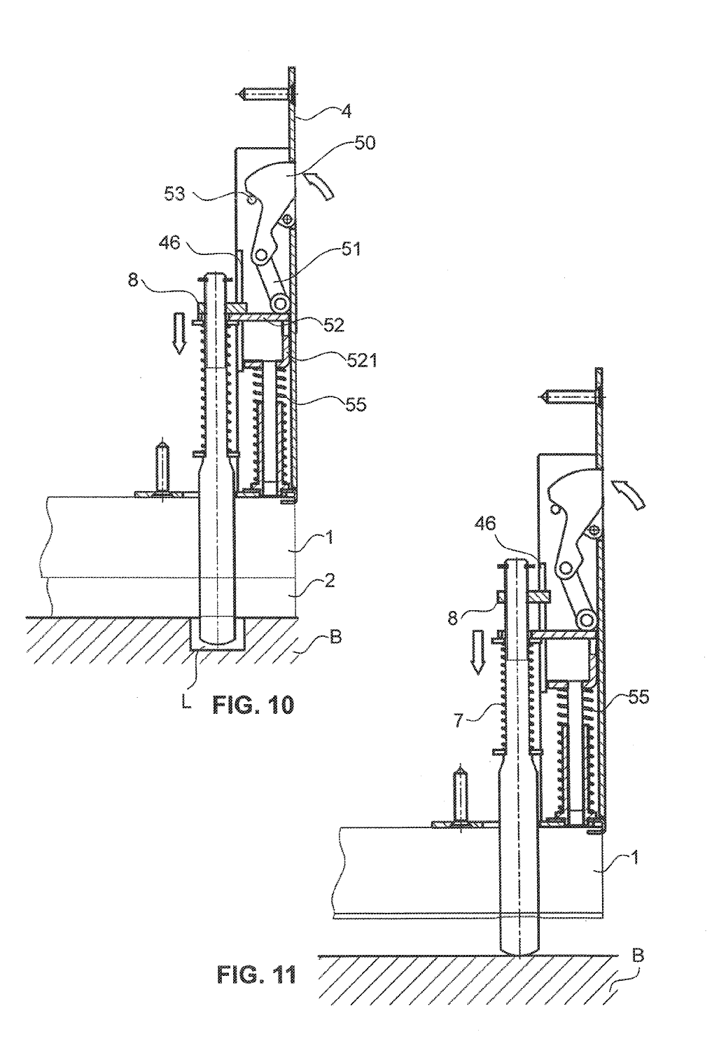

In the situation according to FIG. 10, the active leaf (not illustrated) and the inactive leaf are closed, i.e. the locking position is illustrated. The activating rod of the drop-down seal has been pushed in by abutment against the door frame and the sealing element 2 has been lowered. The sealing element rests with sealing action on the floor B. The triggering element 50 of the flush-bolt mechanism likewise butts against the door frame (not illustrated) and is thus pushed in. The toggle lever 51 has been activated and so pushes the pressure-exerting plate 52 downward. The restoring spring 55 is subjected to stressing. The driver 8 and the locking bolt 6 are lowered together with the pressure-exerting plate 52. In the process, the driver 8 moves with guidance along the gap or the guide groove 46 and serves, together with the force-transmitting spring 7, as a rotation-prevention means for the locking bolt 6. The locking bolt 6 engages in the locking hollow L without resting on the base of the hollow. The inactive leaf, then, is locked.

If the active leaf or the inactive leaf is opened again, the triggering element 50 is no longer subjected to external force. The restoring spring 55 is relieved of stressing again and pushes the triggering element 50 outward. The pressure-exerting plate 52 is raised and, by virtue of the driver 8, also raises the locking bolt into its starting position again. In addition, independently of this, the carrier rail 3 with the sealing element 2 is raised by virtue of the actuating bar being relieved of loading. This means that the starting position according to FIG. 9 has been reached again.

However, if, during the operation of the inactive leaf and of the active leaf being closed, there is no depression present in the floor B, or the depression therein is too small, then the override or safeguard function takes effect. This situation is illustrated in FIG. 11. The override or safeguard function is formed essentially by the displacement capability of the locking bolt 6 relative to the pressure-exerting plate 52. If the triggering element 50, during the operation of the inactive leaf being closed, is pushed in by a stop, e.g. the active leaf, first of all the locking bolt 6 is lowered together with the pressure-exerting plate 52. However, as soon as it butts against the floor, or against some other solid obstruction, and the force of the force-transmitting spring 7 is inadequate, the locking bolt 6 remains in this position, while the pressure-exerting plate 52 continues to be lowered. The pressure-exerting plate 52 first moves away from the driver 8. The carrier rail 3 with the sealing element 2 can nevertheless be lowered, since the actuating rod and the corresponding lowering mechanism of the seal functions independently of the flush-bolt mechanism.

During the operation of the inactive leaf or of the active leaf being opened, the seal is raised again. In addition, it is also the case here that the restoring spring 55 of the flush-bolt mechanism is relieved of stressing, as a result of which the pressure-exerting plate 52 is raised. As soon as it has reached the driver 8, which has remained in an intermediate position, it takes the driver, and thus also the locking bolt 6, along with it in the upward direction into the starting position. The triggering element 50 is pivoted out of the front plate 40 again.

The force-transmitting spring 7 is not absolutely necessary. However, if it is present, as illustrated in this example, the force-transmitting spring 7 acts as a force-transmitting member on the locking bolt 6 when the pressure-exerting plate 52 is being lowered. If the locking bolt 6 strikes against an obstruction which cannot be overcome, or if it has to overcome lateral frictional forces as it penetrates through the seal, then it is moved downward as long as these forces are smaller than the force of the force-transmitting spring 7. In FIGS. 9 and 10, the force-transmitting spring 7 is thus relieved of stressing or is prestressed to a slight extent. In FIG. 11, the floor forms an obstruction which cannot be overcome by the bolt 6. As a result, the force-transmitting spring 7 is then pushed together, and thus subjected to stressing, as displacement of the pressure-exerting plate 52 continues. If the door is opened again, or the pressure-exerting plate 52 is raised, then it is also the case that the force-transmitting spring 7 can be relieved of stressing again and can go back into its starting position. Furthermore, said spring 7 serves as a rotation-prevention means for the bolt 6.

The flush-bolt mechanism according to the invention and the sealing system according to the invention can also be used on an upper end side of the door. In this case, the prestressed force-transmitting spring 7 has to be present, and provides an opposing force to the weight-induced force of the locking bolt. The terms such as “raise”, “lower” and the like used in the description and in the patent claims thus also relate to this type of use, wherein “raise” should be understood as the sealing element being retracted into the housing rail and “lower” should be understood as the sealing element being extended out of the housing rail into a sealing position.

The flush-bolt mechanism according to the invention is suitable, in particular, for use with door seals, preferably with drop-down seals.

### LIST OF REFERENCE SIGNS

1 Seal housing
10 Through-opening
2 Sealing element
20 Through-opening
3 Carrier rail
4 Fastening rail
40 Front plate
41 Fastening plate
411 Slot
42 Screw
43 Stop surface
44 Fastening bracket
45 Fastening screw
46 Gap
5 Actuating mechanism
50 Triggering element
501 Sliding flank
51 Toggle lever
510 First limb
511 Second limb
512 Pivot pin
513 Rolling axis
52 Pressure-exerting plate
520 First limb
521 Second limb
522 Through-opening
53 Stop pin
55 Restoring spring
6 Locking bolt
60 Bolt neck
61 Bolt body
62 Ring
63 Thread
7 Force-transmitting spring
70 First stop ring
71 Second stop ring
8 Driver
80 Lug
B Floor
L Locking hollow
a Longitudinal center axis

1. An automatically actuable flush-bolt mechanism
having a fastening rail for fastening the flush-bolt mechanism in or on a door leaf,
having an actuating mechanism, and
having a locking bolt,
wherein the actuating mechanism comprises a triggering element for automatically displacing the locking bolt from a starting position into a locking position, and also comprises a restoring spring for restoring the locking bolt from the locking position into the starting position,
wherein the flush-bolt mechanism has an automatic override function which, in the event of misalignment of the locking bolt, automatically overrides the actuating mechanism in order to prevent the locking bolt from being lowered all the way into the locking position, wherein the locking bolt has a longitudinal center axis,
wherein
the actuating mechanism has a displacement element, on which the locking bolt rests by way of a driver, wherein the locking bolt can be brought into the locking position by virtue of the displacement element being moved, and wherein the displacement element can be brought into the starting position, together with the driver resting thereon and the locking bolt, by means of the restoring spring,
wherein the displacement element can be displaced in the direction of the longitudinal center axis relative to the locking bolt and driver, and wherein overriding takes place by virtue of this displacement capability.

2. The flush-bolt mechanism as claimed in claim 1, wherein the displacement element forms a bearing surface, which has the locking bolt passing through it in a displaceable manner and on which the driver rests.

3. The flush-bolt mechanism as claimed in claim 2, wherein the locking bolt passes through a through-opening of the displacement element in a displaceable manner

4. The flush-bolt mechanism as claimed in claim 1, wherein the restoring spring is a compression spring, and wherein the displacement element presses onto the restoring spring.

5. The flush-bolt mechanism as claimed in claim 1, wherein the displacement element is of u-shaped design and has an upper and a lower limb, and wherein the lower limb butts with sliding action against a stop surface the fastening rail, and wherein the upper limb is designed to be longer than the lower limb and has the locking bolt passing through it in a displaceable manner.

6. The flush-bolt mechanism as claimed in claim 1, wherein the actuating mechanism has a toggle lever with a first arm and a second arm, which is connected in a pivotable manner to the first arm, wherein the first arm is provided with the triggering element, which projects in front of the fastening rail, and wherein the second arm is operatively connected to the displacement element.

7. The flush-bolt mechanism as claimed in claim 6, wherein the fastening rail has a front plate for bearing on or in a door leaf, and wherein the locking bolt is spaced apart from said front plate such that the toggle lever is located between the longitudinal center axis of the locking bolt and the front plate.

8. The flush-bolt mechanism as claimed in claim 1 wherein the restoring spring is spaced apart from the longitudinal center axis.

9. The flush-bolt mechanism as claimed in claim 8, wherein the fastening rail has a front plate for bearing on or in a door leaf, and wherein the restoring spring is arranged between the front plate and the locking bolt.

10. The flush-bolt mechanism as claimed in claim 1 wherein a force-transmitting spring is present, said spring acting on the locking bolt by way of a first end and acting on the displacement element by way of a second end.

11. The flush-bolt mechanism as claimed in claim 10, wherein the force-transmitting spring surrounds the locking bolt, wherein the force-transmitting spring butts, by way of a first end, against the displacement element, on a side of the latter which is located opposite the driver, and rests, by way of a second end, on a bearing surface, which surrounds the locking bolt and is fixed thereto.

12. The flush-bolt mechanism as claimed in claim 1, wherein the fastening rail has a first guide element, and wherein the driver has a second guide element, which is in engagement with the first guide element, and wherein the locking bolt, in the case of the actuating mechanism being overridden, can be displaced rectilinearly along its longitudinal center axis by means of said two guide elements.

13. A door-sealing system having a door seal and a flush-bolt mechanism, the flush-bolt mechanism
having a fastening rail for fastening the flush-bolt mechanism in or on a door leaf,
having an actuating mechanism, and
having a locking bolt,
wherein the actuating mechanism comprises a triggering element for automatically displacing the locking bolt from a starting position into a locking position, and also comprises a restoring spring for restoring the locking bolt from the locking position into the starting position,
wherein the flush-bolt mechanism has an automatic override function which, in the event of misalignment of the locking bolt, automatically overrides the actuating mechanism in order to prevent the locking bolt from being lowered all the way into the locking position, wherein the locking bolt has a longitudinal center axis,
wherein
the actuating mechanism has a displacement element, on which the locking bolt rests by way of a driver, wherein the locking bolt can be brought into the locking position by virtue of the displacement element being moved, and wherein the displacement element can be brought into the starting position, together with the driver resting thereon and the locking bolt, by means of the restoring spring,
wherein the displacement element can be displaced in the direction of the longitudinal center axis relative to the locking bolt and driver, and wherein overriding takes place by virtue of this displacement capability,
wherein the door seal has a seal housing and a sealing element, and wherein the seal housing and the sealing element each have a through-passage opening through which to guide the locking bolt.

14. The door-sealing system as claimed in claim 13, wherein the door seal has a carrier rail, wherein the sealing element is arranged on said carrier rail, and wherein the carrier rail, together with the sealing element, can be lowered and raised automatically in relation to the seal housing.

15. The door-sealing system as claimed in claim 14, wherein the operation of lowering and raising the sealing element is independent of the actuation of the locking bolt.
